(19) United States
(12) Patent Application Publication
(10) Pub. No.: US 2018/0195246 A1
(43) Pub. Date: Jul. 12, 2018

(54) DEPLOYING MARKER OBJECTS

(71) Applicant: Alejandro Hanssen, Aventura, FL (US)

(72) Inventor: Alejandro Hanssen, Aventura, FL (US)

(21) Appl. No.: 15/870,575

(22) Filed: Jan. 12, 2018

Related U.S. Application Data
(60) Provisional application No. 62/445,532, filed on Jan. 12, 2017.

(51) Int. Cl. E01F 9/70; G08B 5/00; E01F 9/692; E01F 9/30; E01F 9/654; B60R 9/06

(52) U.S. Cl. CPC E01F 9/70; G08B 5/006; B60R 9/06; E01F 9/30; E01F 9/654; E01F 9/692

(57) ABSTRACT

A mechanical cargo shifter is used in cooperation with a mechanical cargo handler, where cargo is organized into cargo positions arranged as rows and columns, and where the cargo handler and cargo are supported upon a platform attached to a truck or trailer. The cargo shifter includes a guide, and a base movable to follow the guide along the platform. The base supports the cargo handler which is fixed to the base. A carriage is attached to the base to be movable in an opposite direction to that of the base. A shifter bar reversibly extends from the carriage to a position adjacent a cargo position. When the carriage is moved, cargo is shifted to create either a cleared position or a loaded position next to the cargo loader, as needed. When a row is fully loaded or emptied, the base moves to the next row area.

### CROSS REFERENCE TO RELATED APPLICATIONS

This application claims the benefit of related U.S. Patent Application No. 62/445,532, filed Jan. 12, 2017, the contents of which are incorporated herein by reference in their entirety.

### FIELD OF THE DISCLOSURE

The disclosure relates to a system and method for deploying marker objects, and in particular, automated loading or unloading of traffic cones from a moving vehicle onto a roadway.

### BACKGROUND OF THE DISCLOSURE

It can be dangerous and difficult for workers to sequentially arrange traffic cones on the roadway, particularly from a moving vehicle. For example, there is risk of falling or other harm if a worker is in the load area of a vehicle, or if any portion of the worker's body extends beyond the confines of the vehicle, or if a worker is on the roadway.

It is additionally difficult for workers to position the cones at a required spacing. Further problems include the time and effort required to load and unload cones into storage and deployment locations on the vehicle.

### SUMMARY OF THE DISCLOSURE

In an embodiment of the disclosure, a device for aligning a mechanical cargo handler with cargo, the cargo organized into cargo positions arranged as rows and columns, the cargo handler and cargo supported upon a platform attached to a truck or trailer, the device comprises a guide associated with the platform; a base movable to follow the guide along a first axis of movement, the movable base supporting the cargo handler in a fixed location upon the base, the cargo handler thereby movable along the first axis of movement; a carriage movably attached to the base to be movable relative to the base along a second axis of movement orthogonal to the first axis of movement, and to be movable relative to the platform along the first axis when the base is moved along the first axis; at least one shifter bar reversibly extendable from a first position adjacent the carriage to a second position extending away from the carriage and adjacent a cargo position, whereby when the shifter bar is in the second position and the carriage is moved along the second axis, cargo is shifted to another position by the shifter bar in order to one of (a) shift cargo from a position adjacent the cargo handler into an adjacent column to create a cleared position thereby enabling the cargo handler to load cargo into the cleared position, and (b) shift cargo into a position adjacent the cargo from an adjacent column to create a loaded position thereby enabling the cargo handler to unload cargo from the loaded position; the base movable along the first axis to move the cargo handler in order to one of (a) retreat from a row of cargo loaded by the cargo handler, and (b) advance to the next row of cargo when the cargo handler has unloaded a row of cargo.

In various embodiments thereof, the guide is selected from an edge of the platform, a guide channel, and a track; the base includes an assembly positioned on each of two opposite sides of the platform, each assembly including a wheel which rolls above an upper surface of the platform, a wheel which rolls along a side surface of the platform, and a wheel which rolls below a lower surface of the platform; guides are placed along the platform to designate a location for rows for cargo; the cargo is selected from buoys, flashing markers, signs, boxes, packages, bricks, pallets, water tanks, fillable barriers, or traffic cones; the cargo is stacked within each position when the position is loaded; and/or individual rows of cargo are positioned upon carts, the carts loadable and unloadable from the platform when full of cargo.

In other variations thereof, the cargo is traffic cones, and where each position holds a stack of traffic cones when loaded; movement of the base is carried out by an actuator; actuator is selected from an electric motor and piston and cylinder; the actuator is an electric motor connected to one of a belt, chain, and drive shaft; the at least one shifter bar is actuated to be reversibly extendable from the first position to the second position by a piston and cylinder; the at least one shifter bar is actuated to be reversibly extendable by an electric motor; there are two shifter bars spaced apart relative to each other at a distance corresponding to a width of a cargo position; and/or the shifter bars slide within channels.

In still further variations thereof, movement of the base, carriage, and shifter bars is controlled by an electronic processor receiving signals from sensors, and actuators responsive to signals from the processor; the processor executes software to coordinate movement of the base, carriage, and shifter bars; the carriage follows a guide when moving along the second axis; the carriage engages the guide to move along the second axis; and/or the carriage engages the base using one of a belt or chain to move along the second axis.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts a cargo handling system of the disclosure, mounted upon a vehicle;

FIG. 1A depicts a drive mechanism for a cone shifter carriage of the disclosure;

FIG. 1B depicts a drive mechanism for moving a base of the system of FIG. 1;

FIG. 2 depicts a cone loading subsystem of the system of FIG. 1;

FIG. 3 depicts a top view of the system of FIG. 1, the cone loading subsystem not shown, a cone stack shifting subsystem depicted;

FIG. 3A depicts a detailed view of a carriage assembly of the cone stack shifting subsystem of FIG. 3;

FIG. 4 depicts a front view of the carriage assembly of FIG. 3A;

FIG. 5 depicts a top view of the carriage assembly of FIG. 3A;

FIG. 6 depicts a front detail view of the cone stack subsystem of FIG. 3;

FIG. 6A depicts an alternative cone gripper of the disclosure;

FIG. 7A-7D depicts a front view of the cone loading subsystem of FIG. 1, illustrating various positions of a cone holder of the disclosure;

FIG. 7E depicts an alternative form of a cone loading subsystem of the disclosure;

FIG. 8A-8D depict a cone transfer subsystem of the system of FIG. 1, showing various positions of a cone transfer arm, and a cone righting element;

FIGS. 9A and 9B depict a cone gripper of the disclosure, mounted to the cone loading subsystem of FIG. 1, showing a deflated and inflated state of an inflation collar, respectively;

FIGS. 9C-9D depict the deflated and inflated states of FIGS. 9A-9B, in combination with a gripped cone;

FIG. 9E depict a cross-section of a vacuum collar of the disclosure, which replaces an inflation collar of the cone gripper of FIGS. 9A-9D;

FIG. 10A depicts a portion of a cone transfer subsystem of the system of FIG. 1, depicting a cam arm;

FIG. 10B depicts a detail view of the subsystem of FIG. 10A, illustrating guide rails and a drive belt;

FIG. 11 depicts a side view cargo movement system usable with the system of FIG. 1, including a suspension component;

FIG. 12 depicts a perspective view of a cargo and system movement subsystem of the disclosure;

FIGS. 13-15 depict an alternative form of cone placement subsystem usable with the system of FIG. 1, showing two positions for a cone catcher of the disclosure;

FIG. 14 depicts a perspective view of the alternative cone placement subassembly of FIG. 13;

FIG. 14A depicts a cone dispenser subsystem of the disclosure, including a cone releasing latch;

FIG. 15 depicts stages of the release of a cone onto a roadway, using the subsystem of FIG. 13;

FIG. 16A-16D depict various stages of movement of the cone placement subsystem of FIG. 14;

FIG. 17 depicts a diagrammatic side view of the system of FIG. 1, the cone transfer subsystem replaced with the subassembly of FIG. 14;

FIGS. 18A-18B depict a device of the disclosure which stands cones upright when they are laying upon the roadway;

FIG. 19 depicts a device of the disclosure for orienting cones for pickup, when they are lying upon the roadway in a misaligned state;

FIGS. 20A-20B depict an alternative cone loading holder of the disclosure, which maintains a relative orientation between a cone gripper of the disclosure, and either a stack of cones or a cone placement subassembly of the disclosure, during tilting of a mounting vehicle;

FIG. 21 depicts a perspective view of the cone righting element of FIGS. 8A-8D; and

FIG. 22 depicts a diagrammatic view of a computing device, some or all components of which are usable with system 100 to control actuation and timing of the various subsystems of the disclosure.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

The disclosure provides a device and method for efficiently and safely placing cones upon a roadway, maintaining the distances and tolerances required by applicable regulations, while meeting needs for placement precision and speed. The disclosure additionally provides for efficiently and orderly storing and deploying of large quantities of cones or markers.

Overview

System 100 of the disclosure transfers cones or other objects to and from a roadway, and can includes various subsystems, such as a movable base 150 which supports a cone stack shifter 200, one or more cone loaders 300, each having an associated cone placer 400. The movable base 150 is movable towards successive rows of stacked marker objects, such as buoys; flashing markers; signs; boxes; packages; bricks; pallets; water tanks; barriers fillable with sand or other material; or traffic cones (hereinafter collectively referred to simply as cones) 10, and stacks of cones in each row are movable laterally by cone stack shifter 200 to be positioned proximate a cone loader 300. Cone loader 300 directs movement of a cone gripper 400 in order to transfer cones between a stack of cones and a cone placer 500, the latter operative to place or collect cones from a roadway or other surface.

Movable Base 150

With reference to the figures, system 100 of the disclosure is connected to a vehicle 20, and can be supported by a frame of vehicle 20, or may otherwise be positioned upon an existing structure, bed, or platform 22 of vehicle 20, which can be a trailer or any other conveyance of a platform. Cones 10 are stacked onto platform 22, which can include movable panels 170, as described further elsewhere herein.

A plurality of cones 10 can be arranged upon platform 22 in series of transverse rows. One or more raised dividers 102 can be provided to aid in aligning and maintaining cones in ordered rows.

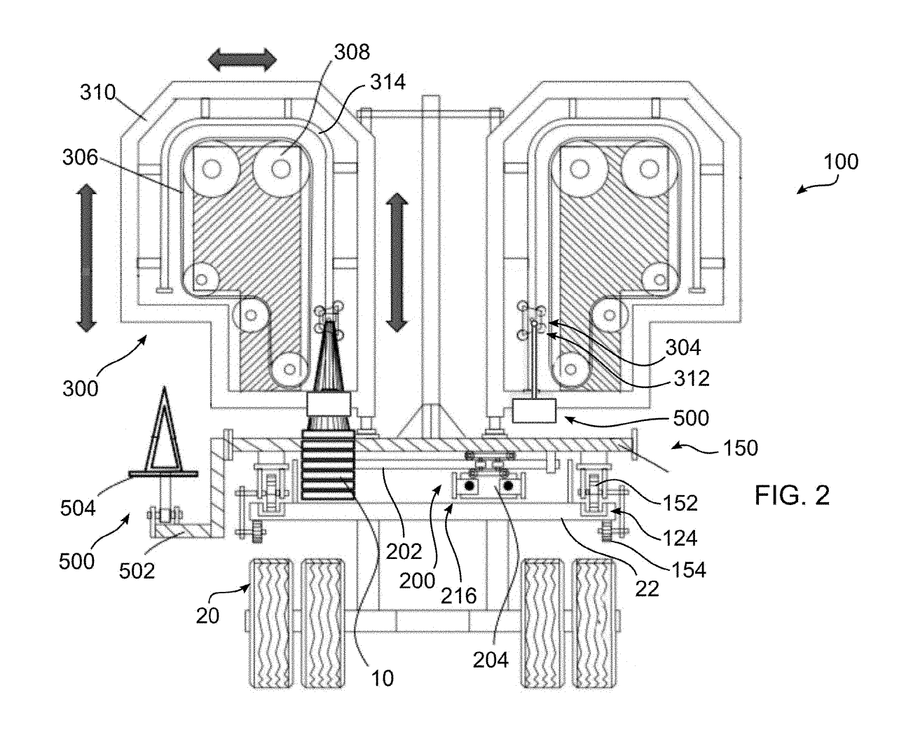

At least one longitudinal guide 124 can be provided, arranged transversely with respect to dividers 102, for example arranged longitudinally along a rectangular truck bed or platform 22, and serve to guide and limit movement of movable base 150. Longitudinal guides 124 can formed as a depression within platform 22, as illustrated in FIG. 2, or can be a separate guide structure which can be attached to vehicle 20. For example, longitudinal guides 124 can have the form of channels as shown, which partially surround wheels 152 of base 150, or guides 124 can have the form of a raised tubular rail or a depression. Longitudinal guides 124 can alternatively be affixed to platform 22 to rest upon platform 22, or to extend from platform 22 to surround an upper part of wheels 152 or other structure of base 150. A capture tab or wheel 154 can additionally be provided, to limit movement of base 150, particularly in the event of excessive tilting of vehicle 20.

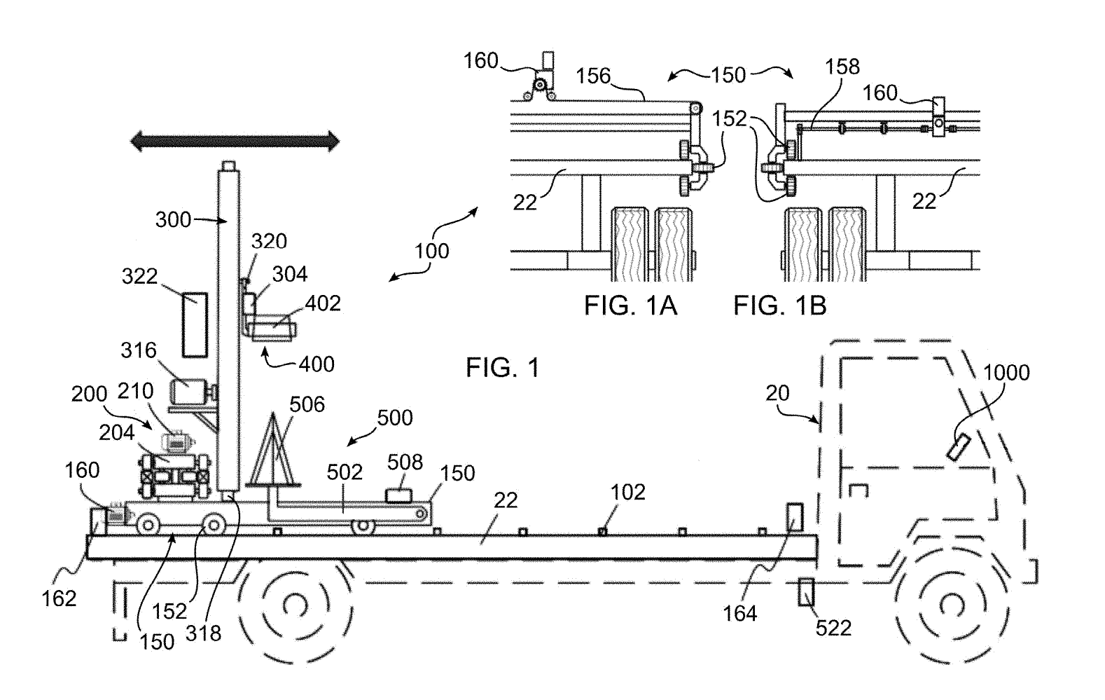

In an embodiment, base 150 moves along a longitudinal axis of a truck bed or other platform, or otherwise advances to subsequent rows of cones for removal or placement of cones, guided by longitudinal guides 124. Movement of base 150 along longitudinal guides 124 can be effectuated by a motor 160, which can be controlled in part by limit switches 162 and 164. Motor 160, and a “motor” herein, can be any known or hereinafter developed type of actuator, including but not limited to an electric motor with associated drive gear, which can include gears, chains, belts, or pulleys, or a pneumatic or hydraulic actuator, including a piston and cylinder, for example (collectively hereinafter ‘motor’). Motors herein can be controlled by any or all of a human operator, with or without an analog controller, or a digital processor, in the instant case to cause motor 160 to move base 150 proximate a row of cones, as described further elsewhere herein. Motors herein can be associated with sensors which determine a position of the associated actuated elements, so that control of the item can be effectively carried out, in the manner described or shown herein, by a person or electronic processor 1100. With reference to FIG. 1A, in one embodiment, motor 160 causes gears or wheels 152 associated with base 150 to rotate in engagement with platform 22, for example via a drive shaft 158, as shown in FIG. 1B. In another embodiment, motor 160 pulls upon a chain or belt affixed to platform 22, or a cylinder and piston is connected between base 150 and platform 22. In FIG. 1A, a belt 156 is driven by a motor to move carriage 204 laterally.

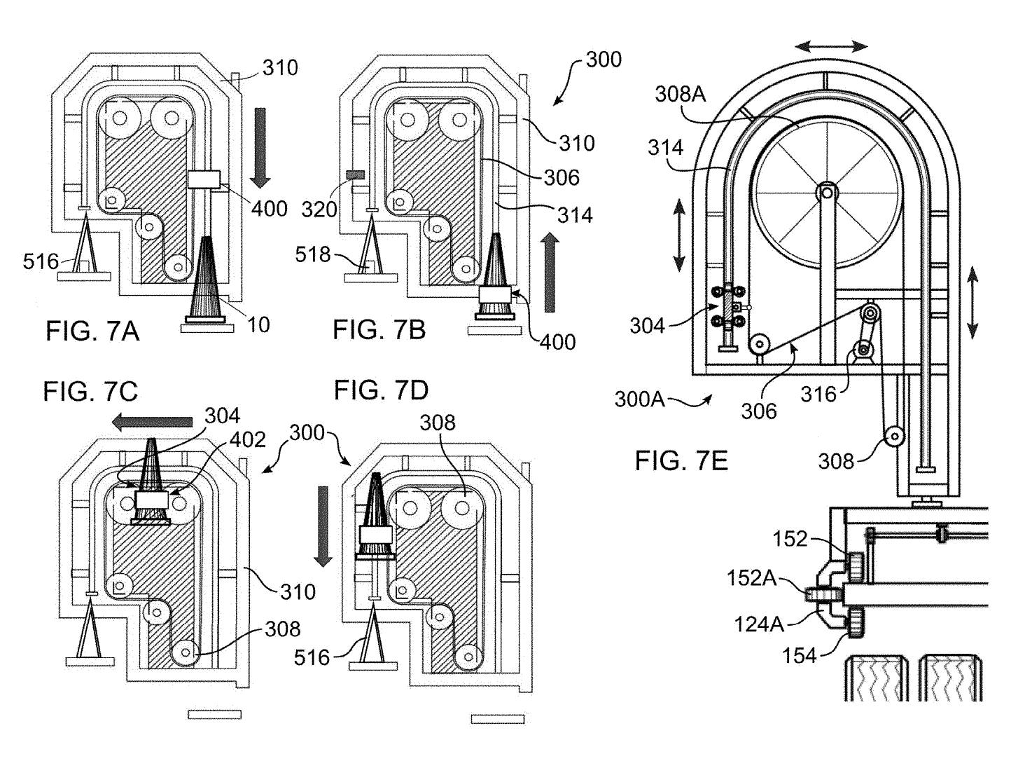

In an alternative, shown in FIG. 7E, longitudinal guide 124A has the form of a yoke which supports sliders or rollers 124A which move along opposing outer sides of platform 22, thereby maintaining a centering of base 150. In this manner, platform 22 does not require modification, and wheel 152 can roll upon a surface of platform 22, with wheel 154 preventing vertical displacement of base 150. In a still further embodiment, shown in FIG. 12, bracket 124B, which supports wheel 152, extends below platform 22 to prevent lifting of base 150.

Cone Stack Shifter 200

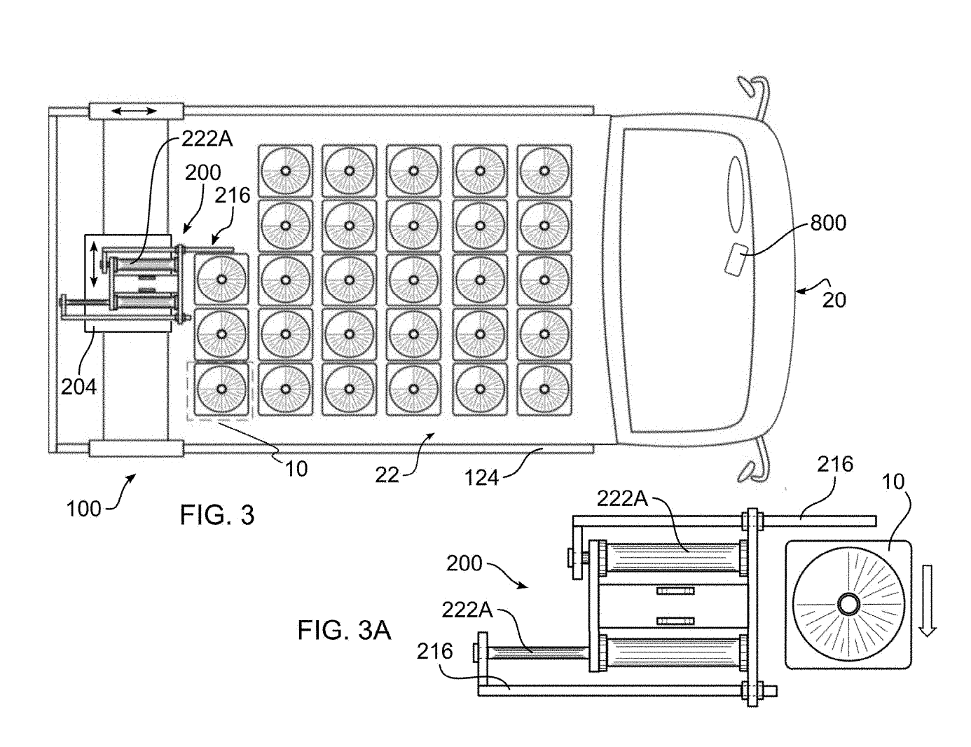

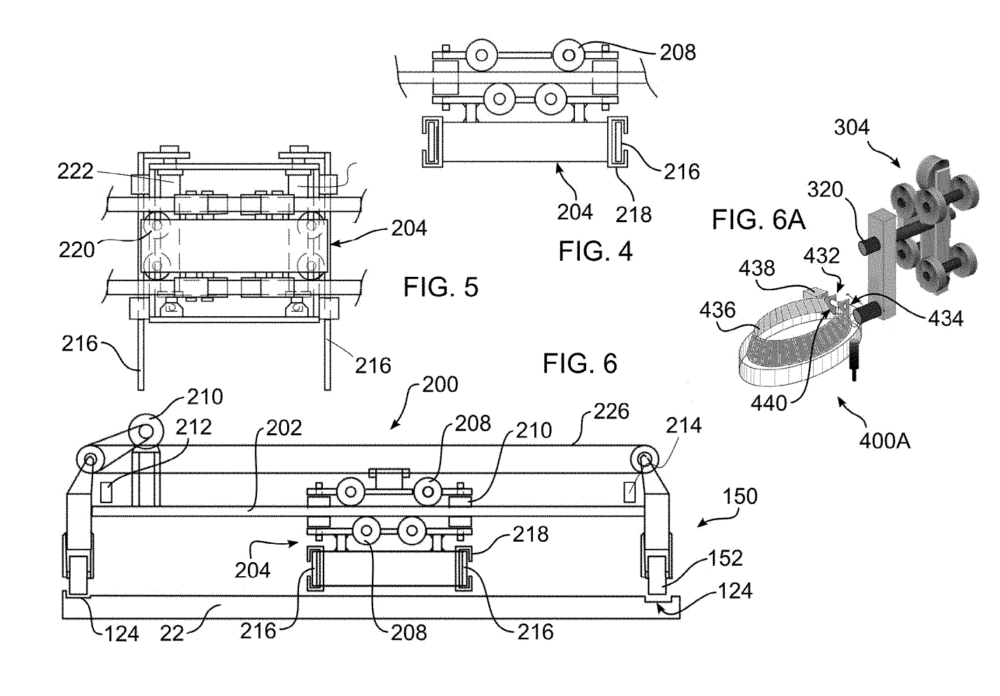

Base 150 moveably supports a cone stack shifter 200 which operates to laterally displace stacks of cones within a row into alignment with carrousel 300, as needed for deployment, or to create space for creating a new stack of cones. AS can be seen in FIG. 3, cones are stacked in a plurality of positions arranged in rows extending between opposite sides of platform 22, and in columns extending from front to back with respect to a longitudinal axis of the vehicle. Cone stack shifter 200 moves cones into a position in front of cone loader 300 when deploying or unloading, or away from a position in front of cone stack shifter when collecting or loading cones. As rows become entirely unloaded, base 150 advances to the next full row and cone stack shifter can shift stacks of cones within a row into a position adjacent to cone loader 300. As rows become entirely loaded, base 150 retreats creating an empty row, exposing a new position for creating a new stack adjacent to cone loader 300. As stacks are completed, cone stack shifter 200 moves completed stacks away from the position adjacent cone loader 300.

Cone stack shifter 200 includes a transverse guide 202 connected to base 150, arranged transversely with respect to a direction of travel of base 150 along longitudinal guides 124. Cone stack shifter 200 includes a laterally displaceable carriage 204 which is moveable along transverse guide 202 along a direction that is orthogonal with respect to a direction of travel of base 150. Movement of carriage 204 along transverse guide 202 can be effectuated by a motor 210 (FIG. 6), which can be an electric motor or other actuator (as described with respect to motor 160), with limit switches 212 and 214 serving to contribute to controlling an extent of movement of carriage 204. Carriage can engage transverse guide 202, for example by driving wheels 208, or alternatively can engage base 150, with a chain or belt 226, in order to move with respect to base 150.

Carriage 204 can be supported by carriage wheels 208 or a sliding member, which contacts transverse guide 202. Other carriage guides 210 can be provided, to control movement of carriage 204. Carriage 204 supports one or more shifter bars 216 which can be actuated to extend to a position adjacent a column of stacked cones or between columns of stacked cones. Once so positioned, carriage 204 can be moved transversely to cause a shifter bar 216 to contact a stack of cones, and move the stack transversely, either towards or away from a position adjacent to a cone loader 300.

Shifter bar 216 is guided by one or more shifter guide channels 218, sliders, or guide wheels 220, and are actuated to extend towards and away from carriage 204 by motors 222 and/or 224, which can be other actuator types as detailed with respect to motor 160. In FIG. 3-3A, which illustrates cone stack shifter 200 without cone loader 300, shifter bars 216 are shown actuated by pneumatic or hydraulic cylinders 222A, with one shifter bar 216 extended, as typical during operations as described herein. In FIG. 5, two shifter bars 216 are shown, each in an extended position. Any or all of a human operator, an analog or digital controller or a digital processor 1105 can be used to cause motors 210, 222, 224, or other actuator, to extend or retract one or more shifter bars 216, and to move carriage 204 laterally, as needed to move stacks of cones proximate a cone loader 300, as described further elsewhere herein.

Two shifter bars 216 are provided to enable shifting an outermost stack of cones inwards from either end of the row, and to otherwise speed operations and reduce lateral movement of carriage 204. In such a configuration, it can be advantageous to space the two shifter bars apart relative to each other by a distance of one row position, again to minimize movement of carriage 204.

Cone Loader 300

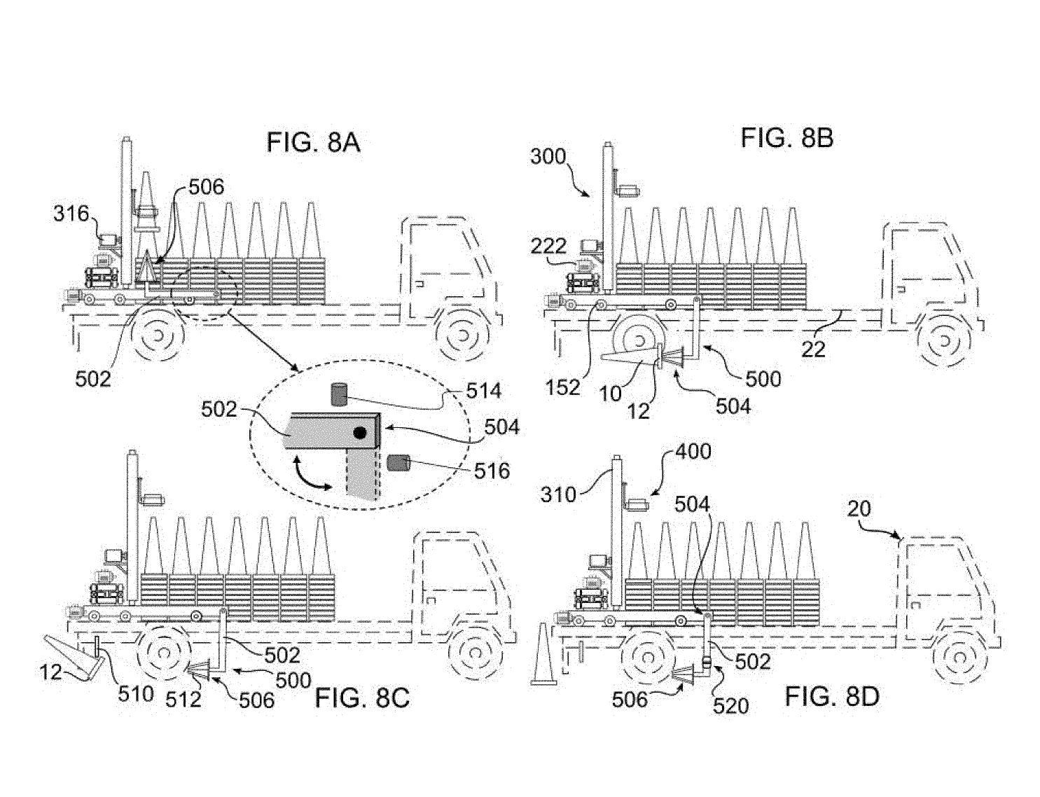

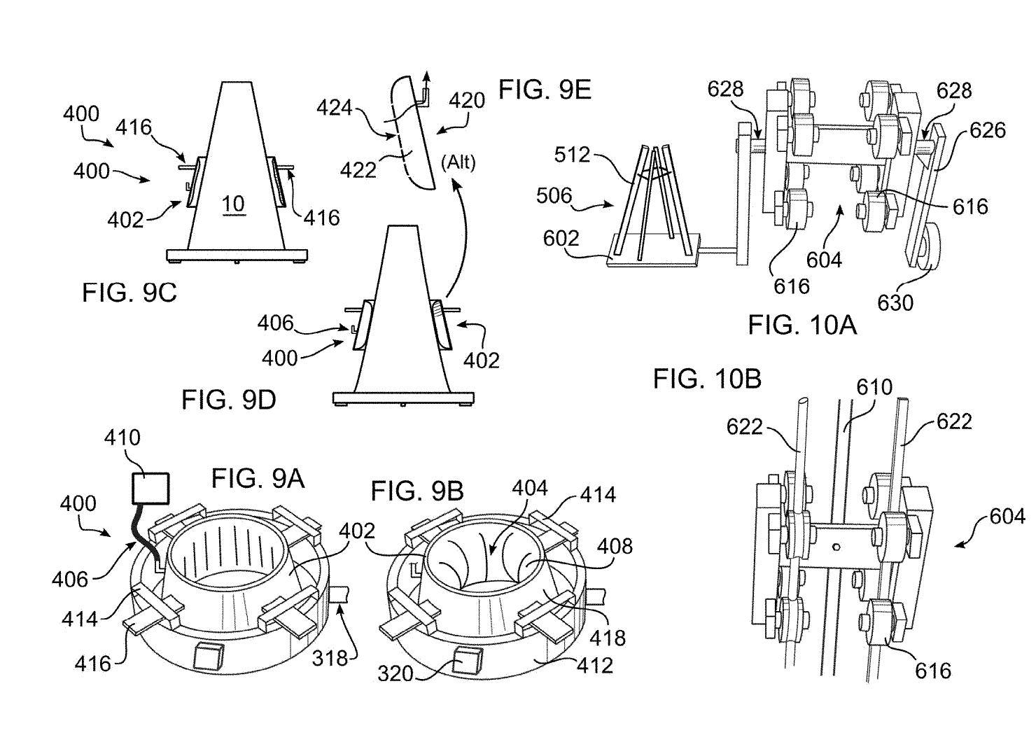

A cargo handler or cone loader 300 moves cones between a storage platform 22 and a cone placer 500 (described further below). Cone loader 300 is affixed to move together with base 150, and operates to create a stack of cones, or remove cones from a stack of cones. A frame 310, positioned upright relative to platform 22, supports a series of pulleys 308 which convey one or more chains or belts 306, to which a holder 304 is affixed. Holder 304 (FIGS. 2, 9) pivotally supports a cone gripper 400 (discussed further below), and sequentially moves in vertical, horizontal, then vertical directions, as shown by heavy arrows in FIGS. 2 and 7. These movements correspond to lifting/lowering a cone from/to a stack, shifting the cone laterally towards/away from a side edge of the vehicle, and lowering/raising the cone to/from a cone placer 500. In an embodiment, holder 304 includes a plurality of guides or rollers 312 which follow a guide rail 314, wherein holder 304 is conveyed along guide rail 314 through a connection with belt 306. One or more pulleys 308 are rotated by a motor 316 (FIG. 8A) or other actuator (as described with respect to motor 160), to cause movement of belt 306 and holder 304. Any or all of a human operator, an analog or digital controller 322, or a digital processor 1105 can be used to cause motor 316 to operate. Belt 306 is caused to move in a forwards and reverse reciprocating manner, in order to shuttle holder 304 from a stack of cones 10 to cone placer 500, and back again to a stack of cones. Herein, controller can be a separate analog or digital processor that works in conjunction with a unifying system controller, such as computer 1100; or which can independently control a subsystem, for example using input from a person or one or more sensors; or which represents a function carried out by a master controller/computer 1100.

A plurality of cone loaders 300 can be used, for example on opposite sides of a vehicle, or multiple cone loaders 300 on a single side of a vehicle. In an embodiment, one or more of the plurality of cone loaders are synchronized to produce a coordinated spacing of cones. For example, where it is desired to place cones at a faster rate than is possible with a single cone loader 300, a plurality of cone loaders 300 can be arranged in relative sequential alignment and mutually timed in operation to place cones alternately, e.g. wherein using two cone loaders 300 can yield approximately a two-fold increase in deployment or collection speed.

With reference to FIG. 7, belt 306 moves to position holder 304 and an associated cone gripper 400 over the uppermost cone 10 in a stack of cones. The movement is in a clockwise manner for a cone loader 300 that is mounted upon a right-hand side of platform 22, and counterclockwise for a rearward facing mounting, or for a forward facing left hand mounting.

One or more sensors 320 (FIGS. 7A-B), for example a pressure or light sensor, or a mechanical switch, detects when gripper 400 is positioned at the uppermost stack position, in order to cause a controller or processor 1100 to stop movement of belt 306. Once a cone has been gripped/engaged, or released/disengaged as needed by gripper 400, movement of belt 306 takes place in a counter-clockwise manner, positioning holder 304 proximate cone placer 500 (FIGS. 7C-D). At this point, transfer of a cone between gripper 400 and placer 500 takes place, following which movement of belt 306 once again takes place in a clockwise manner, again to position gripper 400 at the top of a stack of cones. This sequence is repeated until all desired cones are deployed or retrieved.

When an entire stack of cones has been retrieved, cone stack shifter 200 moves the newly created stack of cones aside, making room to create a new stack. If all stacks in a row are completed, base 150 moves away from the completed row of stacked cones, in order to begin a new row of stacked cones at an empty position. Base 150 can move forwards or backwards, relative to stacks of cones, and relative to a forward direction of travel of vehicle 20, depending upon whether base 150 is mounted upon platform 22 or vehicle 20 to face forward or backward. In the illustrations, base 150 is mounted to face in a forward direction, but other orientations can include rearwards or sideways, for example.

When an entire stack of cones has been deployed, cone stack shifter 200 moves an existing stack of cones in front of cone loader 300. If all stacks in a row are deployed, base 150 advances towards the next row of stacked cones, in order to resume deployment of an existing stack, as described.

In an embodiment, frame 310 pivots upon pin 318 (FIG. 2) to be retracted within the confines of vehicle 20 when not deploying cones.

Alternative Cone Loader 300A

FIG. 7E depicts an alternative cone loader 300A, in which instead of multiple upper pulley wheels, as shown in FIGS. 7A-7D, a single large upper wheel/pulley 308A conveys holder 304 in a smooth, circular path from the top of a stack upon platform 22 to a position proximate cone placer 500, to deliver cones as otherwise described with respect to FIGS. 7A-7D. By using a single upper pulley/wheel, there is a significant reduction in abrupt angular transitions from vertical to horizontal movements imposed upon holder 304, and thus less jarring of inflation collar 402, particularly as may be amplified by movement of vehicle 20. This can result in reduced incidences of dislodging cones 10 from inflation collar 402.

Cone Gripper 400

With reference in particular to FIGS. 9A-9D, cone gripper 400 includes a cone clamp or inflation collar 402 forming an interior aperture 404 which is positionable over a cone 10, whereby a portion of the cone extends through aperture 404. Inflation collar 402 includes material which forms a ring-shaped bag 408, which can formed of a resilient or non-resilient fabric or material, which is mounted to the inside of a circular frame 418. Frame 418 can be non-circular for gripping objects having a non-circular shape, in which case frame 418 and bag 408 have a shape which conforms to the object to be gripped. Gripper 400 is connected to holder 304 of cone loader 300. As holder 304 is moved as described above, gripper 400 pivots upon a pin or other hinge 320 which passes through or is connected to holder 304, to enable gripper 400 to maintain a vertical orientation with respect to platform 22, in order to orient a plane defined by aperture 404 to be parallel to platform 22, and accordingly, parallel to a base of a cone stacked upon platform 22. As such, inflation collar 402 can be lowered over a cone 10 in a deflated state (FIG. 10C), resulting in a relatively larger aperture 404 than when in an inflated state, allowing a portion of cone 10 to pass into aperture 404. One or more fluid conveying passageways, for example one or more air lines 406, convey an inflation fluid into inflation collar 402 (FIGS. 9B, 9D), and conduct away fluids when deflating inflatable collar 402 (FIGS. 9A, 9C). Valves (not shown) within collar 402, or associated with a controller 410, can be controlled by any or all of a human operator, an analog controller, or a digital processor to cause air to be passed into or released from inflation collar 402. In an embodiment, vacuum pressure is applied to air line 406 to more rapidly and completely deflate bag 408 and thus inflation collar 402.

Cones 10 are designed to be grasped by human hands. The inventors have found that prior art cone handling devices form a different type of grip, which can include holding from the cone base, pressing, inverting, or laying down the cone. The alternate forms of grasping the cone lead to grip failure, premature cone wear, wear of the cone feet, and failure of a deployment or retrieval procedure, with attendant costs and safety considerations. In particular, cones are designed to be stacked and aligned vertically. The inventors have further found that stacking cones in a different orientation than vertical, for example horizontal, contributes to inefficient storage, difficulties in gripping and separating cones, whether carried out by people or machines, and increased friction upon cone surfaces leading to wear. In contrast, inflation collar 402 grasps the cones in a similar way to the human hand, by surrounding the cone with a conformable, inflatable, “pillow” like structure that does not produce pressure points, and which provides a substantial amount of contact surface leading to a reliable grip with minor or insignificant distortion to the shape of the cone. Bending or twisting of cone 10 is further avoided. Likewise, by avoiding insufficient contact and forming a reliable grip over a large surface area, slippage and its attendant wear are avoided. In addition, by using inflation, a misaligned cone is centered within inflation collar 402, resulting in a more accurate and reliable transfer to cone placer 500.

A cone contacting surface of inflation collar 402 can be fabricated with a material that is flexible, and forms a non-slip and non-wearing contact with cones 10. For example, such material can include natural rubber, or a synthetic polymer, including for example the same material from which cones 10 are fabricated, and can include cloth or other reinforcing fibers.

As shown in FIGS. 9A-9D, cone gripper 400 can include a centering ring 412 having circumferentially disposed loops or apertures 414 which slidingly receive mating blades 416 circumferentially extending from inflation collar 402. Centering ring 412 maintains engagement of cone gripper 400 within holder 304, while enabling inflation ring 402 to move laterally to a limited extent, in order to allow inflation ring 402 to move laterally to follow a contour of a cone 10 during inflation of inflation collar 402, centering cone 10 within inflation collar 402. In this embodiment, centering ring is pivotally connected to holder 304 as described elsewhere herein, instead of inflation collar 402. Accordingly, through connection with centering ring 412, inflation collar 402 maintains a level orientation during movement vertically, laterally, or circularly of holder 304, as described herein.

FIG. 6A illustrates an alternative cone gripper 400A, wherein inflation collar 402 is replaced by a mechanical grip collar 430 including a split ring 436 of metal, polymer, fabric, or other material that is pivotally attached to holder 304 as otherwise described herein, and which is split so that the split ends 432, 434 can be drawn together to reduce the circumference of the split ring, and thereby grip a cone 10. Conversely, the split ends can be separated to increase a circumference of split ring 436, and thereby release a cone. A motor 438 can drive a threaded shaft 440 which is threaded into at least one split end 432, 434, and rotated by the motor to bring the split ends 432, 434 closer together or farther apart. Motor 438 thus forms an actuator which can be controlled by computer 1100/digital processor/CPU 1105 as otherwise described herein.

Cone Placer 500

With reference to FIGS. 1, 3, and 8A-D in particular, cone placer 500 transfers a cone between cone loader 300/cone gripper 400 and the deployment surface, typically a paved travel surface. Cone placer 500 includes a pivot arm 502 pivotally connected at one or more hinges or pivots 504 to base 150, having a cone catcher 506 positioned at a distal end of pivot arm 502. Cone catcher 506 includes one or more guide rods 512 (FIG. 10A) or panels connected to pivot arm 628/328 and which contact an interior surface of cone 10 in order to repeatably and reliably align cone 10 with respect to cone catcher 506, and thereby to form a predetermined alignment of cone 10 with arm 502, base 150, and cone gripper 400.

A motor 508 or other actuator (as described with respect to motor 160) is connected to pivot 504 or arm 502 to cause rotation of arm 502 about pivot 504, between an upper position (FIG. 8A), and a lower position (FIG. 8B-D). In the upper position, cone catcher 506 is oriented vertically, with respect to an upright position of a held cone, and catcher 506 is positioned adjacent to cone loader 300, aligned for capturing a cone released and dropped from cone gripper 400. In the lower position, a cone held by cone catcher 506 is oriented at or nearly horizontally. Additionally, a length of pivot arm 504 has been predetermined, selected, or set, to position a base 12 of a held cone into contact with the deployment surface, thereby causing cone 10 to be pushed off of cone catcher 506 by contact with the deployment surface.

Once a cone has been pushed out of contact with cone catcher 506 and vehicle 20, it is lying on the roadway with its base oriented to extend upwards from a surface of the roadway (FIG. 8B). A lever arm 510 extends downwards from vehicle 20 towards the deployment surface. Lever arm 510 can have an L-shape in FIG. 21, or may include a lateral extension 524 (FIG. 21). In either configuration, lever arm 510 is advantageously removably connected to vehicle 20, so that it can be stowed when not in use. Lever arm 510 has a portion which is disposed at a height from the roadway to contact an upper extending portion of base 12 of cone 10, to push base 12 to cause cone 10 to be turned to lie in a stable and upright position upon the roadway. Lever arm 510 advantageously has a horizontally extending portion 512 (FIG. 3) which increases a likelihood of contacting base 12 of cone 10, which may vary somewhat in placement, from cone to cone.

Cones can be retrieved either by driving vehicle forwards or backwards. To retrieve cones in a reverse direction of travel, lever arm contacts an upright cone initially, and pushes the cone to lie upon its side, with an opening to an inside of the cone facing cone catcher 506, which enters and supports the cone. Arm 502 is then actuated to move the cone into position for cone gripper 400. To retrieve cones driving forwards, pivot arm 502 is moved to a rearwards position upon base 150, aft of cone loader 300, whereby a pivoting of arm 502 forwards positions a retrieved cone adjacent to cone gripper 400, as shown in FIGS. 10A-10D.

In an alternative retrieval apparatus, shown in FIG. 8D, cone catcher 506 can be pivotally mounted to a distal portion of arm 502, or arm 502 is pivotally mounted or rotatable. In either alternative, pivoting is under the control of a motor or actuator 520, to alternately face cone catcher 506 forwards in a direction of forward motion of vehicle 20, and to face rearwards, under analog or digital control. Cone catcher 506 faces forward during cone retrieval, and is pivoted to face rearwards before arm 502 is pivoted to the upright position, whereupon cone gripper 400 can retrieve the cone.

One or more position sensors 514, 516 communicate a position of arm 502 to a person, for example via an analog indicator, or a digital processor, as part of coordinating various functions of system 100, as described herein. Similarly, a sensor 518 can be provided to sense the presence of a cone 10 upon cone catcher 506. Other sensors 522 can be provided for detecting a speed or direction of vehicle 20, or other aspects of vehicle 20, in order to electronically coordinate the movement of various components of system 100 as described herein.

Operation

The disclosure thus supports placing or “deployment”, as well as “collection” of cones or other objects between a vehicle and a deployment surface, such as a parking lot, travel surface, or roadway (collectively, roadway). Each of system 100 sequentially lifts one cone at a time from a stack of cones on a platform on a vehicle, and places the cone on the roadway, so that cones are placed in a spaced sequence of predetermined gap, which tracks a path of the vehicle. The spacing of the sequence is dependent upon the speed of operation of system 100, and the speed of the vehicle, and may be predetermined.

In one embodiment, to deploy cones, the following can be carried out using system 100:

cone holder 304 moves vertically to position cone gripper 400 over the uppermost cone in a column of stacked cones, stopping in a predetermined position with respect to the uppermost cone with the aid of data from sensor 320;

inflation collar 402 of cone gripper 400 is inflated to securely attach the uppermost cone 10 to cone holder 304;

cone holder 304 is moved upwards, then horizontally, then downwards, to position the gripped cone over cone catcher 506, whereupon inflation collar 402 is deflated, and cone 10 is released onto upwards facing cone catcher 506;

arm 502 is rotated to lower cone catcher towards the roadway, placing cone base 12 into contact with the roadway, whereupon friction with the roadway removes cone 10 from cone catcher 506; and

as vehicle 20 moves, lever arm 510 contacts upwardly extending cone base 12 to tip cone 10 onto its base, in an upright orientation;

while arm 502 is deploying a cone, sensors determine if there are no cones left in the column position in front of cone loader 300, in which case cone stack shifter 200 extends a shifter bar 216 along the far side of a stack of cones, with respect to a location of cone loader 300, and carriage 204 moves laterally to cause a stack of cones to be shifted into place in front of cone loader 300;

if there are no stacks of cones available for lateral shifting by cone stack shifter 200, base 150 advances forwards to the next row of columns of stacked cones;

after inflation collar 402 has released cone 10, cone holder 304 is moved upwards, horizontally, and then lowered onto the next uppermost cone, after which the foregoing process is repeated.

In one embodiment, to collect cones, the following can be carried out using system 100:

as vehicle 20 moves, lever arm 510 contacts an upright cone, and tips the cone onto its side, resulting in an upwardly extending cone base 12, and the cone resting in a sideways orientation with the larger opening of the cone facing towards cone catcher 506;

arm 502 has been rotated to lower cone catcher 506 towards the roadway, whereupon movement of the vehicle causes cone catcher 506 to enter the cone, after which arm 502 rotates to move the captured cone into an upright orientation and within aperture 404 of inflation collar 402;

inflation collar 402 of cone gripper 400 is inflated to securely attach the cone presented by cone catcher 506, whereupon cone holder 304 is moved upwards, then horizontally, then downwards, to position the gripped cone onto a stack of cones next to cone loader 300, guided by data from position sensor 320, whereupon inflation collar 402 is deflated to release cone 10 onto the uppermost position of the stack of cones;

while arm 502 is collecting the next cone, sensors have determined if the current stack of cones cannot be stacked any higher, for example the stack is higher than cone loader 300 can reach for placement of another cone, and if so, cone stack shifter extends a shifter bar 216 along a side of the completed stack, and thereafter carriage 204 moves laterally to cause the stack to be moved away from a position in front of cone loader 300, leaving a free area next to cone loader 300 for creation of a new stack of cones;

if the entire row adjacent to cone loader 300 contains full stacks of cones, base 150 moves rearwards away from the stacked cones to create space for creating a new row of columns of stacked cones;

after inflation collar 402 has released cone 10 onto the uppermost position of a stack of cones, cone holder 304 is moved upwards, horizontally, and then lowered to receive the next collected cone, after which the foregoing process is repeated.

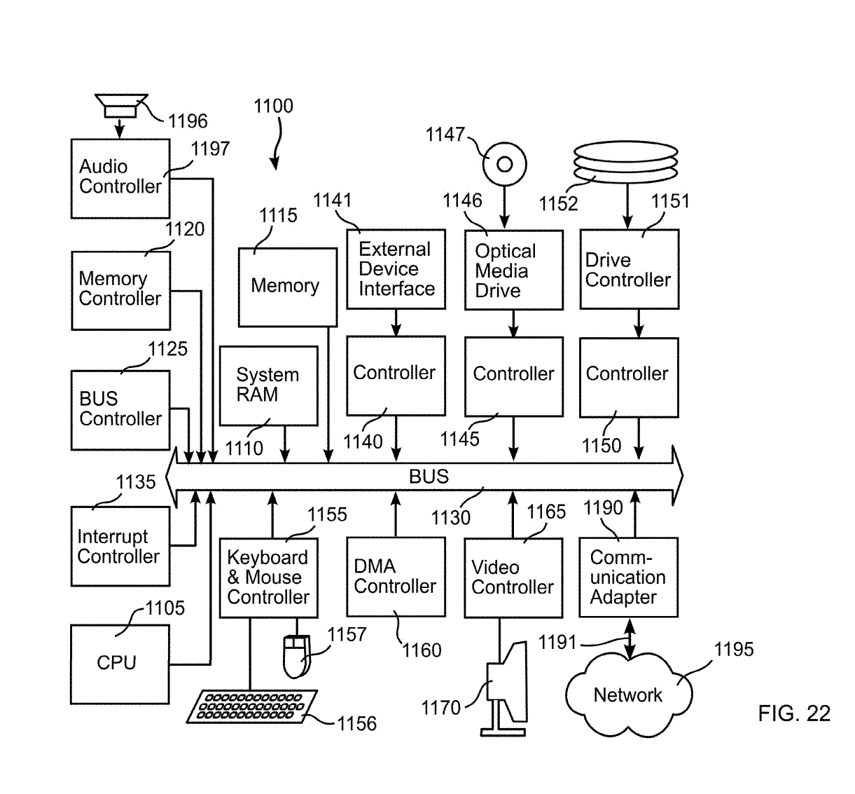

FIG. 22 details a computer system which can be used to control the various functions of system 100 as described herein. More particularly, sensors can be provided for any or all of determining a location of cones on a stack, a location of stacks of cones, a height of a stack of cones, a position without cones, the presence of a cone within cone gripper 400, upon cone catcher 506, or upon the roadway. Additionally, sensors can be provided for determining a position of the following relative to other elements of system 100, or to the environment, of: vehicle 20, platform 22, guide 124, base 150, wheels 152, 154, cone stack shifter 200, carriage 204, shifter bars 216, cone loader 300, carrousel 302, belts 306, holder 304, cone gripper 400, inflation collar 402, aperture 404, inflation valves or actuator valves, cone placer 500, pivot arm 502, pivot 504, cone catcher 506, lever arm 510, and other components of system 100 described herein. In addition, sensors can be used to determine a position of components of motors or other actuators, and an inflation state of inflation collar 402.

Data from sensors can be provided to a processor 1100/CPU 1105 which contains software encoding instructions for analyzing the sensed data and causing actuators of the disclosure to carry out the functions and operations of system 100 as described herein. For example, the processor can be provided with a desired distance between cones, and can use sensed data of the rate of travel of the vehicle to adjust the speed of any or all of base 150, carriage 204, shifter bars 216, belt 306, inflation collar 402, and pivot arm 502 to cause cones to be placed at the correct timed interval.

The processor can use sensed data to coordinate the operation of the preceding elements, so that, for example, a cone is released by inflation collar 402 onto cone catcher 506 only when cone catcher 506 is in position below inflation collar 402, or to inflate collar 402 only when inflation collar 402 is in position around an uppermost cone in a stack. It would be understood by one skilled in the art that other sensors than are described herein may be present, and can be used to provide needed data to processor 1100/1105.

In an embodiment, some of the functions described herein are carried out in response to sensed data acted upon by a processor, and some or all of the functions can be carried out by independent or cooperative analog or digital timers, mechanical actuators, or a combination of such elements. For example, analog switches can be used to initiate actuation of an element, for example raising of arm 502, at a time during which belt 306 is in motion to deliver cone holder 304 to the location for dropping a cone onto cone catcher 506. The various timers can be adjusted to produce the desired timing of components. In an embodiment, various of the needed actuations can be controlled by a human operator, including starting or stopping overall operation, or controlling any or all of the elements controlled by actuators. Finally, certain elements can be moved by people. For example, stacks of cones can be positioned proximate cone loader 300, or cones can be removed from cone catcher 506 and placed onto the roadway.

Alternative Cone Placer 600

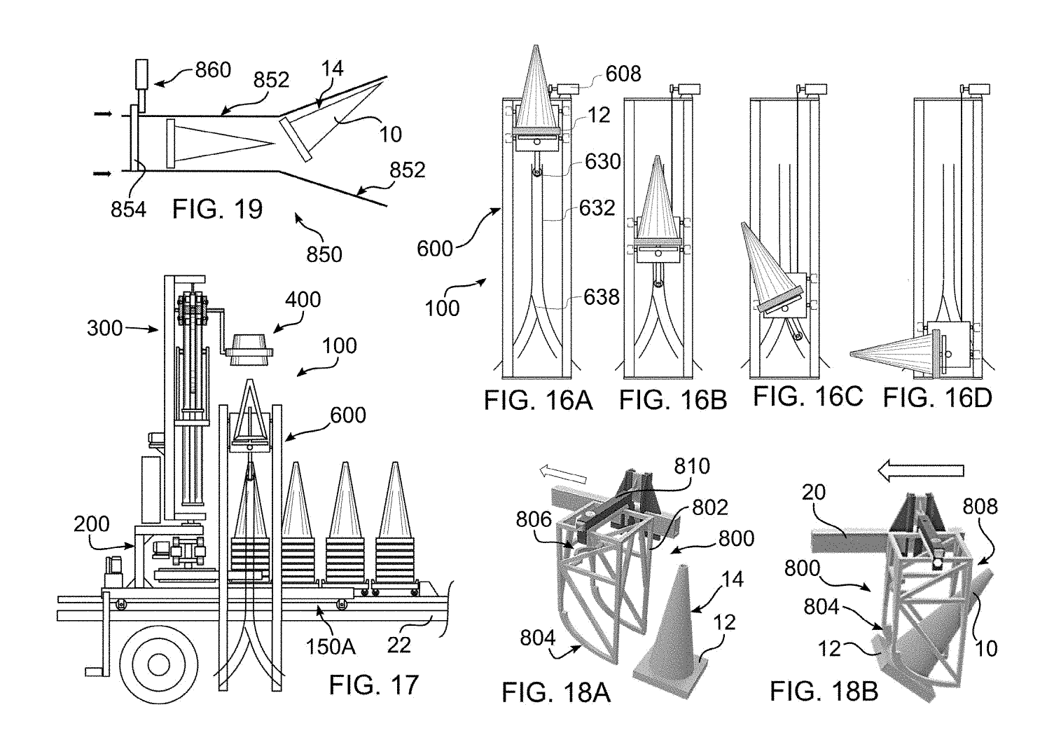

With reference to FIGS. 10A-17, in an alternative embodiment, cone placer 600 replaces cone placer 500 (although both forms can be used upon a single vehicle). Cone placer 600 enables cones to be placed upon the roadway when the vehicle is travelling either forwards or reverse. More particularly, a cone catcher 506 can be positioned upon a cone catcher base 602, with base 602 pivotally mounted to a vertically moveable placer carriage 604. A guide frame 620 provides a pathway along which carriage 604 moves, the movement carried out by motor 608 or other actuator (as described with respect to motor 160).

As shown in FIGS. 10B and 14, belt 610 can be driven by motor 608, which cooperates with a series of pulleys 618 to convey carriage 604 to upper and lower positions, with respect to the roadway. It should be understood, however, that in various example alternatives (not shown) (a) a motor can be placed upon carriage 604, cooperate with a toothed guide upon frame 620, or (b) a hydraulic actuator, or any other configuration can be used to move carriage 604 vertically as desired, under control of a human or electrical operator.

In the embodiment shown, carriage 604 includes wheels 616, which are captured by rails 622 of guide frame 620, to limit movement of carriage 604 along a predetermined vertical path. As an alternative to wheels 616, carriage 604 can include sliding elements (not shown) which engage guide frame 620, or carriage 604 could slide upon poles (not shown), or another arrangement can be provided when enables carriage 604 to move along a predetermined vertical path.

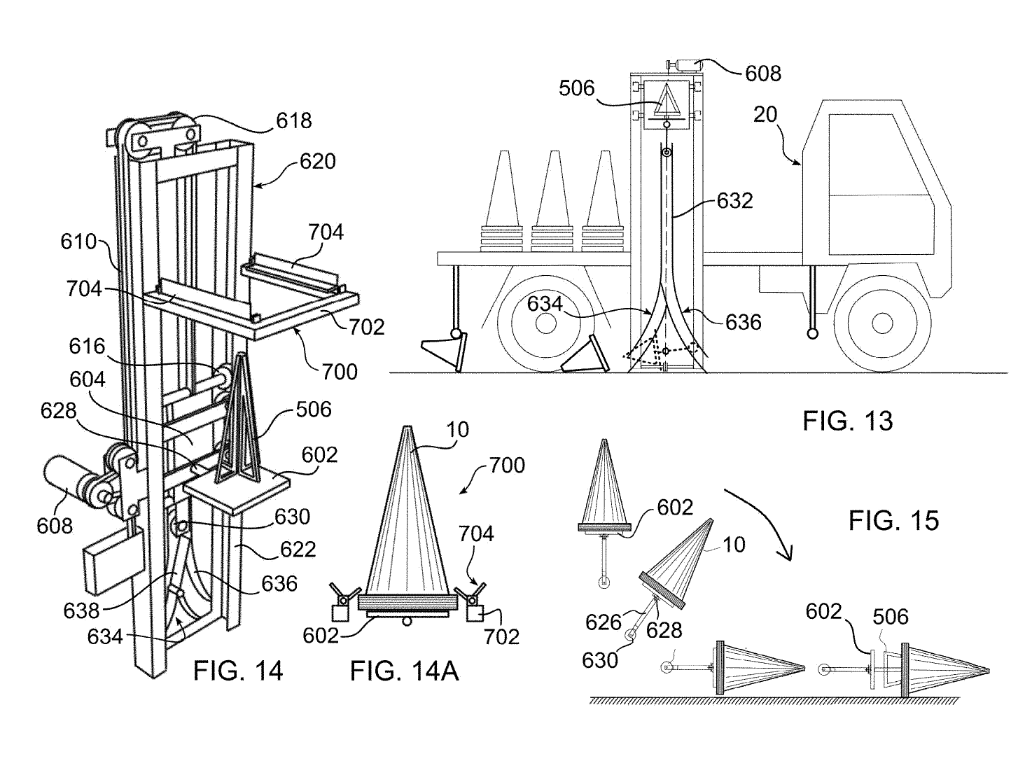

A pivot shaft 628 is connected to cone catcher base 602, if present, or pivot shaft 628 is connected directly to cone catcher 506. Pivot shaft 628 is pivotally supported within carriage 604. A pivot arm 626 extends transversely from an axis of pivot shaft 628, and includes a cam follower, in the example shown cam wheel 630, although a sliding member can be used. Cam wheel 630 travels within a pivot channel 632, which divides into two divergent cam guide paths 634, 636. A deflector panel 638, actuated by hand, or by an electric, hydraulic, or pneumatic piston, or an electric motor, or other actuator as described herein, is positioned to direct cam wheel 630 along a predetermined one of the cam guide paths 634, 636. When deflector panel 638 is actuated or positioned to the right, as viewed in FIG. 14, cam wheel will travel along cam guide 634 tilting cone catcher 506 to point cone 10 towards one direction (FIG. 15), and if deflector panel 638 is positioned to the left (FIG. 13), cam wheel will travel along cam guide 636, tilting cone catcher 506 to point cone 10 towards the opposite direction. As shown in FIG. 13, it is desired to point cone 10 in a direction opposite to a direction of travel of vehicle 20.

Cone Dispenser

With further reference to FIGS. 14 and 14A, a cone dispenser 700 can be provided which releases cones onto cone catcher 506 sequentially, as needed. A support frame 702 is attached to vehicle 20 or, as illustrated, to guide frame 620, which is in turn attached to vehicle 20. Two opposing cone latches 704 cooperate to retain the bottom-most cone 10 of a stack upon support frame 702. Latches 704 each having the form of two elongate panels joined along a mutual edge, forming a v-shape or right angle, into which an edge of a cone base 12 is retained. When a cone is to be released onto cone catcher 506, for example at a timed sequence coordinated with the vertical approach of cone catcher 506, cone latches 704 are each tilted (FIG. 14A) by an electrical motor or other actuator (as described with respect to motor 160), to thereby create an opening through frame 702 which is larger than cone base 12, allowing a single cone 10 to fall upon cone catcher 506, for subsequent release onto the roadway. Cone latches 704 raise only sufficiently to enable a single base 12 to pass, after which they rapidly resume the former orientation which occludes passage through frame 702, and retains the next base 12 of a stack upon frame 702, in readiness for the next release.

Accordingly, it should be understood that a plurality of cones can be positioned upon cone dispenser 700, or alternatively, cones can be placed upon cone dispenser 700 one at a time, in order to be released at a predetermined time with respect to other components of system 100, and particularly a position of cone catcher 506. In one embodiment, a person or a machine loads cones onto cone dispenser 700. In another embodiment, cone loader 300 places cones upon cone dispenser 700. In this manner, cone loader 300 and cone dispenser 700 can operate at different speeds, with cone loader 300 suspending loading when a maximum number of cones have been stacked upon cone dispenser 700. Sensors (not shown) can be positioned to indicate to a person or electronic controller when a supply of cones upon cone dispenser 700 is low, after which additional cones 10 can be loaded onto cone dispenser 700. As with cone placer 500, a plurality of cone placer 600 can be positioned upon a single vehicle. Alternatively, cone dispenser 700 can be omitted, and cone loader 300 can place a single cone upon cone catcher 506 at a time, as described with respect to cone placer 500.

Cones are positioned upon and collected from the pavement in the same manner when using either cone placer 600 or cone placer 500. As additionally illustrated in FIG. 15, to place a cone onto a roadway, cone catcher 506 is tilted to position cone base 12 into contact with the roadway, whereupon it is pushed off of cone catcher 506 by friction. After being pushed out of contact with cone catcher 506, cone 10 rests upon an edge of a side surface of base 12, with an opposite side surface of base 12 extending upwards.

Alternative Base Platform 150A

With reference to FIG. 12, an alternative base platform 150A includes rolling cone carts 170, which can hold a single stack of cones or as illustrated, a row of cones 10. Cart 170 enables successive rows of stacked cones to be easily rolled into position proximate base 150 and carrousel 300. In one embodiment, base 150 can be fixed in position, enabled by the ability to easily move carts 170. Carts 170 include sliders or wheels 172 which roll upon cart guides 174, which extend along platform 122, extending away from base 150. In FIG. 12, cone loader 300, cone placer 500, and other subsystems are not shown, for clarity.

In one embodiment, as shown in FIG. 12, base 150 is mounted at a height relative to platform 22 that is higher than carts 170, whereby as carts 170 are emptied, base 150 can advance over empty carts 170 to move to the next row to be unloaded. This is carried out, in one embodiment, using brackets 124B as described elsewhere herein. Alternatively, yoke 124A can be configured to be taller, or any other mounting for base 150 can be likewise elevated to enable carts 170 to pass beneath. For clarity, FIG. 12 does not show cone loader 300 and associated elements, and does not show the various drive mechanisms for base 150 described elsewhere herein.

Alternatively, as cone stacks within a given row are emptied, the lightened, empty cart 170 can be removed, and a loaded cart can be rolled in proximity to base 150 and cone loader 300. Alternatively, when retrieving cones, a full cart 170 can be rolled away from base 150, and an empty cart 170 can be positioned proximate base 150. A stop 176 can be provided to keep wheels 152, 172 upon guides 174.

Using carts 170, a vehicle 20 can be quickly loaded using a forklift or hoist, as fully loaded carts 170 can be quickly positioned upon platform 22, ready for deployment. Similarly, base 150 can be configured with forward or rearward facing cone loaders 300, or a mix of forward and rearward facing cone loaders 300, and rolled or actuator driven to a position within vehicle 20 as required. A hook (not shown) can be used to secure cart 174 in a desired location.

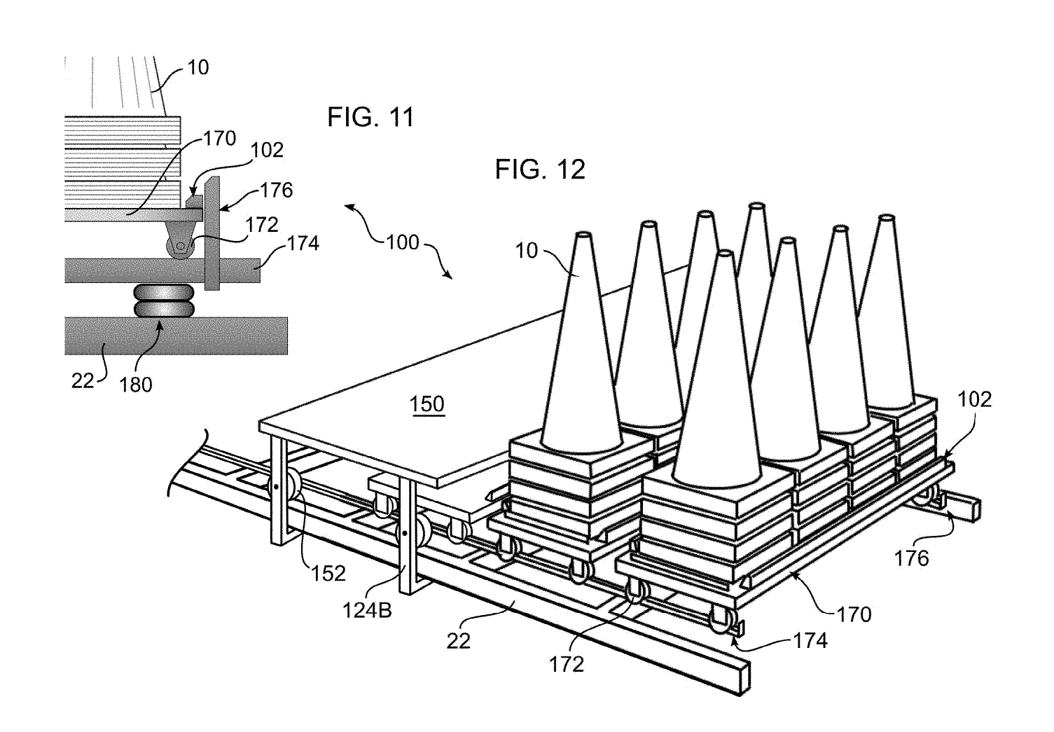

Additionally shown in FIG. 11 is a resilient suspension bushing 180 supporting guide rails 174 or 124. Bushing 180 is attached or supported by vehicle 20, for example to platform 22, and weight upon guides 124/174 is transferred through bushing 180 to vehicle 20. Bushing 180 can have the form of a coil spring, a pneumatic spring, leaf spring, resilient polymeric block, or any other shock absorption material or device, which helps to cushion and maintain a load upon guides 124/174 level, and to prevent abrupt or pinpoint loading upon rails 124/174, promoting smooth rolling or sliding of carts 170 or base 150.

Cone Stander 800

In FIGS. 18A-B, a cone stander 800 includes a frame 802 which includes two leading curved edge rails 804. Frame 802 can be either fixed to vehicle 20, or movably connected to vehicle 20, whereby either vehicle 20 is steered to cause a fallen cone to enter between curved edge rails 804, which are mutually spaced apart to admit passage therebetween of a conical portion 14 of cone 10, but to contact upper edges of base 12 of cone 10 and slidingly engage them to push base 12 into a horizontal orientation with respect to the roadway. A leading cross-member 806 prevents over-rotation of base 12, helping to ensure base 12 maintains the horizontal orientation after cone 10 passes out of a rearward facing opening 808 of cone stander 800.

In an embodiment, an actuator (not shown) moves cone stander 800 closer or farther from vehicle 20, to align edge rails 804 with a fallen cone. In one embodiment, the actuator can extend or retract frame mount 810, under control of a sensor which determines a position of a cone upon the roadway, or by a human operator.

Cone Stander 800 can be mounted to the truck at any position after the deployment location, or can be mounted on a separate vehicle or trailer which is following the deployment vehicle. Alternatively, cone stander 800 can be used separately from a deployment or collection activity, to maintain organization of deployed cones, for example.

Cone Aligner 900

With reference to FIG. 19, a cone aligner 850 serves to orient a cone 10 upon the roadway for capture by cone catcher 506. A frame mount 810, for example of the type shown in FIG. 18A-B, attaches two angular or curved alignment rails 852 to vehicle 20. A frame mount 820 is provided, and as described for frame mount 810, an actuator as described herein can move cone aligner 860 closer or farther from vehicle 20 for alignment with a cone 10 upon the roadway. As can be seen in FIG. 19, as cone aligner 850 advances in the direction of the arrows, a cone that lies upon the roadway with the opening to an inside of the cone facing at an angle with respect to cone catcher in the position shown in FIGS. 8B-8D (or in a forward-facing orientation with respect to a direction of travel of vehicle 20). Alignment rails 852 form a widening profile which pushes a misaligned conical 14 of portion of cone 12 (right hand cone) inwards into a proper alignment for entry of cone catcher (left hand cone). Alignment rails 850 can have the form of tubes, rails, or panels which slidingly engage a side surface of conical portion 14 of cones 10. Alignment rails are each connected to frame 854 which extends in an upwards direction and connects to frame mount 860.

Cone aligner 900 can be positioned upon vehicle 20 at a position in advance of cone catcher 506, and can alternatively be mounted upon another vehicle, for example.

Alternative Vacuum Collar 420

With reference to FIG. 9E, in an embodiment, inflation collar 402 is replaced by a vacuum collar 420 which is like inflation collar 402 as otherwise described herein, but which produces vacuum, causing cones to be gripped by vacuum pressure. In this embodiment vacuum collar 402 is rigid or semi-rigid and forms an interior air space or vacuum plenum 422, and includes apertures 424 which face cone 10. Suction is applied to air line 406 to cause air to be drawn into plenum 420 through apertures 422, drawing material of cone 10 against vacuum collar 420, thereby releasably connecting vacuum collar 420 to cone 10.

Alternative Holder 304A

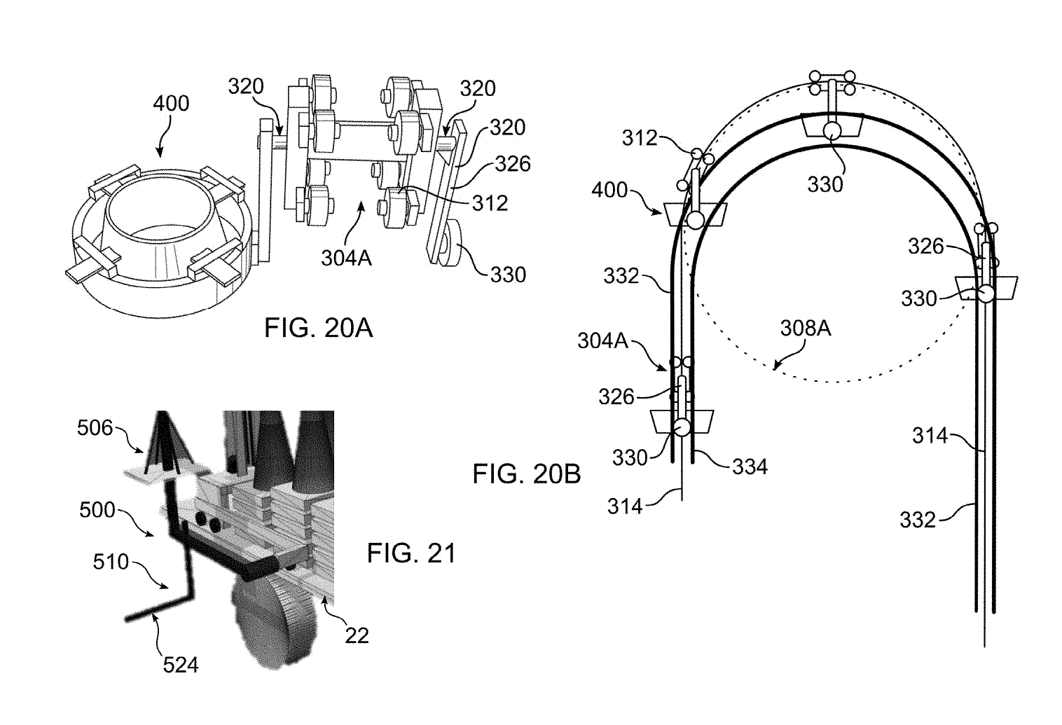

Cone holder 304A is the same as holder 304 described elsewhere herein, except as follows. As shown in FIGS. 20A-20B, holder 304 is provided with a pivot arm 326 which is analogous to pivot arm 626 described with respect to alternative cone placer 600. Pivot arm is connected to holder 304 via an extension to pivot shaft 328 which rotatably passes through holder 304A. A slider or cam wheel 330 is positioned at a distal end of pivot arm 326. Two cam rails 332, 334 are disposed opposite each other, to form a cam guide path therebetween, along which cam wheel 330 travels during movement of holder 304. In FIG. 20B, four holders 304 are illustrated, in order to illustrate the function of holder 304A, however it should be understood that only one holder 304A is positioned upon cone loader 300/300A.

FIG. 20B diagrammatically illustrates holder 304A as viewed from behind cone loader 300A. Holder 304A follows guide rail 314, moved by belt 306 (not shown in FIG. 20B) or other actuator, as described elsewhere herein. Cam guides 332 and 334 form a greater relative mutual separation at the top of a stroke of wheel 308A, in order to allow cam wheel 330 to move freely during a relatively horizontal portion of travel of holder 304A. However, cam guides 332 and 334 are evenly spaced relative to each other along vertical portions of the path of holder 304A, and form a gap that is sized to slidingly trap cam wheel 330 therebetween, and thereby maintain pivot arm 326 and pivot shaft 320 in a fixed orientation, and thus cone gripper 400 in a predetermined fixed orientation during pickup or transfer of cones between a cone stack or cone placer 500.

Accordingly, if for example vehicle 20 is tilted upon the roadway, cam gripper will be properly oriented with respect to a cone stack upon platform 22, or with respect to cone catcher 526, which would each be tilted, as they are each mounted to the tilted vehicle. As such, inflation collar aperture 404 is properly aligned to pass onto an uppermost cone 10, and a cone gripped by cone gripper 400 is properly aligned for placement onto cone catcher 506, as shown and described herein.

System 100 can be installed on the bed of a truck, as shown and described herein, or may alternatively be installed upon a trailer in a like manner. System 100 can be used to deploy or collect cones, and can alternatively be used to collect and redeploy cones in a single pass, for example to relocate a sequence of cones already positioned upon the roadway. For example, an instance of system 100 can be mounted to the right or left side of the vehicle, and the other system 100 can be mounted upon the other of the left and right sides. As one system collects cones, the other can be redeploying cones on an opposite side of the truck. This can be advantageous, for example, to reallocate lanes during rush hour.

In one embodiment, an operator sits upon a platform connected to the vehicle so that operations of system(s) 100 can be observed, and controlled in part or completely. Alternatively, the operator can control operations using a video monitor in a cab of the vehicle. Still further, all operations of system 100 can be controlled by one or more processors controlling actuators as described herein, or by any other form of automation known or hereinafter developed.

In another embodiment, platform 150 can move in a direction transverse to a forward or reverse direction of vehicle 20, while carts 170 cone then move in a direction aligned with a longitudinal to a direction of travel of vehicle 20.

Inflation clamp 402 can be sized to surround objects of any size, including for example barrels, such as 55-gallon barrels, or polymeric forms of such barrels, or can grip and position tubes or poles which are narrower than a typical cone 10.

System 100 can be formed of any durable materials, including metals and plastics, for example, including steel and/or aluminum flat stock, tubes, and square channel. Wheels, shafts and pulleys can be made from, for example, metal or polymeric material, or any other sufficient durable material. As described above, actuators can be any form of device which produces movement of one part with respect to another, such as electric motors, shape memory alloys, pneumatic or hydraulic actuators, chain or pulley drives, electromagnetically driven linear actuator, stepper motors, rack and pinion drives, or any other actuator known or hereinafter developed. control box. System 100 can be powered from energy generated and/or stored on vehicle 20, or can include an independent power source, including for example batteries, stored compressed gas, solar panels, and/or an electrical generator. Appropriate warning signs and lighting can be provided to increase the safety of operators and others. A laser guidance or alignment system can be used to ensure cones are deployed along predetermined locations, or to align subassemblies of system 100. A collision safety bumper can be connected to vehicle 20, as vehicle 20 can be expected to move along a roadway at a speed substantially slower than ambient traffic.

In an embodiment, cone loader 300 is replaced by a robotic arm (not shown) which uses cameras or other optical elements to guide the robot arm, and inflation collar 402 can be positioned at the end of the arm. The robotic arm can further be used to place cones upon the roadway, thereby directly lifting cones from a stack, and placing them upon the roadway, or collecting cones from the roadway, and placing them upon a stack. Accordingly, inflation collar 402 can be used to grip cones which are upon the roadway, and to release cones onto the roadway. In an embodiment, cone catcher 506 is replaced by inflation collar 402, whether in the afore-described robot arm configuration, or elsewhere herein as described for cone catcher 506.

Example Computing System

FIG. 20 is a block diagram of an electronic device and associated components 1100, which can be used in carrying out the disclosure. In this example, an electronic device 1152 is a wireless two-way communication device with voice and data communication capabilities. Such electronic devices communicate with a wireless voice or data network 1150 using a suitable wireless communications protocol. Wireless voice communications are performed using either an analog or digital wireless communication channel. Data communications allow the electronic device 1152 to communicate with other computer systems via the Internet. Examples of electronic devices that are able to incorporate the above described systems and methods include, for example, a data messaging device, a two-way pager, a cellular telephone with data messaging capabilities, a wireless Internet appliance or a data communication device that may or may not include telephony capabilities.

The illustrated electronic device 1152 is an example electronic device that includes two-way wireless communications functions. Such electronic devices incorporate communication subsystem elements such as a wireless transmitter 1110, a wireless receiver 1112, and associated components such as one or more antenna elements 1114 and 1116. A digital signal processor (DSP) 1108 performs processing to extract data from received wireless signals and to generate signals to be transmitted. The particular design of the communication subsystem is dependent upon the communication network and associated wireless communications protocols with which the device is intended to operate.

The electronic device 1152 includes a programmable logic controller (PLC), single board computer (SBC), or other circuit including a microprocessor, 1102 that controls the overall operation of the electronic device 1152. The microprocessor 1102 interacts with the above described communications subsystem elements and also interacts with other device subsystems such as flash memory 1106, random access memory (RAM) 1104, auxiliary input/output (I/O) device 1138, data port 828, display 1134, keyboard 1136, speaker 1132, microphone 1130, a short-range communications subsystem 1120, a power subsystem 1122, and any other device subsystems.

A battery 1124 is connected to a power subsystem 1122 to provide power to the circuits of the electronic device 1152. The power subsystem 1122 includes power distribution circuitry for providing power to the electronic device 1152 and also contains battery charging circuitry to manage recharging the battery 1124. The power subsystem 1122 includes a battery monitoring circuit that is operable to provide a status of one or more battery status indicators, such as remaining capacity, temperature, voltage, electrical current consumption, and the like, to various components of the electronic device 1152.

The data port 1128 of one example is a receptacle connector 104 or a connector that to which an electrical and optical data communications circuit connector 1100 engages and mates, as described above. The data port 1128 is able to support data communications between the electronic device 1152 and other devices through various modes of data communications, such as high-speed data transfers over an optical communications circuits or over electrical data communications circuits such as a USB connection incorporated into the data port 1128 of some examples. Data port 1128 is able to support communications with, for example, an external computer or other device.

Data communication through data port 1128 enables a user to set preferences through the external device or through a software application and extends the capabilities of the device by enabling information or software exchange through direct connections between the electronic device 1152 and external data sources rather than via a wireless data communication network. In addition to data communication, the data port 1128 provides power to the power subsystem 1122 to charge the battery 1124 or to supply power to the electronic circuits, such as microprocessor 1102, of the electronic device 1152.

Operating system software used by the microprocessor 1102 is stored in flash memory 1106. Further examples are able to use a battery backed-up RAM or other non-volatile storage data elements to store operating systems, other executable programs, or both. The operating system software, device application software, or parts thereof, are able to be temporarily loaded into volatile data storage such as RAM 1104. Data received via wireless communication signals or through wired communications are also able to be stored to RAM 1104.

The microprocessor 1102, in addition to its operating system functions, is able to execute software applications on the electronic device 1152. A predetermined set of applications that control basic device operations, including at least data and voice communication applications, is able to be installed on the electronic device 1152 during manufacture. Examples of applications that are able to be loaded onto the device may be a personal information manager (PIM) application having the ability to organize and manage data items relating to the device user, such as, but not limited to, e-mail, calendar events, voice mails, appointments, and task items.

Further applications may also be loaded onto the electronic device 1152 through, for example, the wireless network 1150, an auxiliary I/O device 1138, Data port 1128, short-range communications subsystem 1120, or any combination of these interfaces. Such applications are then able to be installed by a user in the RAM 1104 or a non-volatile store for execution by the microprocessor 1102.

In a data communication mode, a received signal such as a text message or web page download is processed by the communication subsystem, including wireless receiver 1112 and wireless transmitter 1110, and communicated data is provided the microprocessor 1102, which is able to further process the received data for output to the display 1134, or alternatively, to an auxiliary I/O device 1138 or the Data port 1128. A user of the electronic device 1152 may also compose data items, such as e-mail messages, using the keyboard 1136, which is able to include a complete alphanumeric keyboard or a telephone-type keypad, in conjunction with the display 1134 and possibly an auxiliary I/O device 1138. Such composed items are then able to be transmitted over a communication network through the communication subsystem.

For voice communications, overall operation of the electronic device 1152 is substantially similar, except that received signals are generally provided to a speaker 1132 and signals for transmission are generally produced by a microphone 1130. Alternative voice or audio I/O subsystems, such as a voice message recording subsystem, may also be implemented on the electronic device 1152. Although voice or audio signal output is generally accomplished primarily through the speaker 1132, the display 1134 may also be used to provide an indication of the identity of a calling party, the duration of a voice call, or other voice call related information, for example.

Depending on conditions or statuses of the electronic device 1152, one or more particular functions associated with a subsystem circuit may be disabled, or an entire subsystem circuit may be disabled. For example, if the battery temperature is low, then voice functions may be disabled, but data communications, such as e-mail, may still be enabled over the communication subsystem.

A short-range communications subsystem 1120 provides for data communication between the electronic device 1152 and different systems or devices, which need not necessarily be similar devices. For example, the short-range communications subsystem 1120 includes an infrared device and associated circuits and components or a Radio Frequency based communication module such as one supporting Bluetooth® communications, to provide for communication with similarly-enabled systems and devices, including the data file transfer communications described above.

A media reader 1160 is able to be connected to an auxiliary I/O device 1138 to allow, for example, loading computer readable program code of a computer program product into the electronic device 1152 for storage into flash memory 1106. One example of a media reader 1160 is an optical drive such as a CD/DVD drive, which may be used to store data to and read data from a computer readable medium or storage product such as computer readable storage media 1162. Examples of suitable computer readable storage media include optical storage media such as a CD or DVD, magnetic media, or any other suitable data storage device. Media reader 1160 is alternatively able to be connected to the electronic device through the Data port 1128 or computer readable program code is alternatively able to be provided to the electronic device 1152 through the wireless network 1150.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A device for aligning a mechanical cargo handler with cargo, the cargo organized into cargo positions arranged as rows and columns, the cargo handler and cargo supported upon a platform attached to a truck or trailer, the device comprising:
a guide associated with the platform;
a base movable to follow the guide along a first axis of movement, the movable base supporting the cargo handler in a fixed location upon the base, the cargo handler thereby movable along the first axis of movement;
a carriage movably attached to the base to be movable relative to the base along a second axis of movement orthogonal to the first axis of movement, and to be movable relative to the platform along the first axis when the base is moved along the first axis;
at least one shifter bar reversibly extendable from a first position adjacent the carriage to a second position extending away from the carriage and adjacent a cargo position, whereby when the shifter bar is in the second position and the carriage is moved along the second axis, cargo is shifted to another position by the shifter bar in order to one of
(a) shift cargo from a position adjacent the cargo handler into an adjacent column to create a cleared position thereby enabling the cargo handler to load cargo into the cleared position, and
(b) shift cargo into a position adjacent the cargo from an adjacent column to create a loaded position thereby enabling the cargo handler to unload cargo from the loaded position;
the base movable along the first axis to move the cargo handler in order to one of
(a) retreat from a row of cargo loaded by the cargo handler, and
(b) advance to the next row of cargo when the cargo handler has unloaded a row of cargo.

2. The device of claim 1, wherein the guide is selected from an edge of the platform, a guide channel, and a track.

3. The device of claim 1, wherein the base includes an assembly positioned on each of two opposite sides of the platform, each assembly including a wheel which rolls above an upper surface of the platform, a wheel which rolls along a side surface of the platform, and a wheel which rolls below a lower surface of the platform.

4. The device of claim 1, wherein guides are placed along the platform to designate a location for rows for cargo.

5. The device of claim 1, wherein the cargo is selected from buoys, flashing markers, signs, boxes, packages, bricks, pallets, water tanks, fillable barriers, or traffic cones.

6. The device of claim 5, wherein the cargo is stacked within each position when the position is loaded.

7. The device of claim 1, wherein individual rows of cargo are positioned upon carts, the carts loadable and unloadable from the platform when full of cargo.

8. The device of claim 1, wherein the cargo is traffic cones, and where each position holds a stack of traffic cones when loaded.

9. The device of claim 1, wherein movement of the base is carried out by an actuator.

10. The device of claim 9, wherein the actuator is selected from an electric motor and piston and cylinder.

11. The device of claim 9 wherein the actuator is an electric motor connected to one of a belt, chain, and drive shaft.

12. The device of claim 1, wherein the at least one shifter bar is actuated to be reversibly extendable from the first position to the second position by a piston and cylinder.

13. The device of claim 1, wherein the at least one shifter bar is actuated to be reversibly extendable by an electric motor.

14. The device of claim 1, wherein there are two shifter bars spaced apart relative to each other at a distance corresponding to a width of a cargo position.

15. The device of claim 1, wherein the shifter bars slide within channels.

16. The device of claim 1, wherein movement of the base, carriage, and shifter bars is controlled by an electronic processor receiving signals from sensors, and actuators responsive to signals from the processor.

17. The device of claim 16, wherein the processor executes software to coordinate movement of the base, carriage, and shifter bars.

18. The device of claim 1, wherein the carriage follows a guide when moving along the second axis.

19. The device of claim 18, wherein the carriage engages the guide to move along the second axis.

20. The device of claim 18, wherein the carriage engages the base using one of a belt or chain to move along the second axis.
